(19) United States
(12) Patent Application Publication
(10) Pub. No.: US 2006/0143539 A1
(43) Pub. Date: Jun. 29, 2006

(54) Device and method for debugging embedded system

(75) Inventors: In Geol Chun, Seoul (KR); Chae Deok Lim, Taejon (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/095,486

(22) Filed: Apr. 1, 2005

(30) Foreign Application Priority Data
Dec. 17, 2004 (KR) 2004-108116

(51) Int. Cl. G06F 11/00

(52) U.S. Cl. 714/39

(57) ABSTRACT

A device and method for debugging an embedded system are provided. A host system (100) includes: a user interface (110) for managing an interface with a user; a debugging engine (120) for performing a debugging process; and a JTAG command generator (130) for receiving an information necessary for the debugging process from the debugging engine (120) and generating a corresponding debugging command. A JTAG signal generator (200) converts the debugging command inputted from the host system (100) into a JTAG signal. A target system includes: a TAP for decoding the JTAG signal; and a microprocessor (320) for receiving the decoded debugging command through the TAP controller (310) and executing a necessary information and a debugging command. Accordingly, software for the embedded system can be debugged at a low cost by using a PC without any special hardware.

### BACKGROUND OF THE INVENITON

1. Field of the Invention

The present invention relates to a device and method for debugging an embedded system, and more particularly, to a device and method for debugging an embedded system, in which an embedded system having a joint test action group (JTAG) port can be debugged using a PC without any additional expensive equipment.

2. Description of the Related Art

As is well known, an embedded system is a system designed to respond to or process a user input or an external input. That is, functions that are logically defined within the system must be correctly executed in sequence. Also, a real-time based embedded system must satisfy the condition that the functions must be executed in time.

Such an embedded system has been developed in a different way from the general application software and a lot of knowledge about hardware as well as software is demanded. Thus, it is very difficult to develop a reliable system. In order to stably develop an enhanced embedded system, a device for effectively debugging the functions according to the characteristics of the system is absolutely required. Since the debugging of the embedded system cannot be directly achieved at a target according to the characteristics of the system, it is constructed with a remote debugging environment consisting of a host and a target.

There are two debugging devices. One debugging device emulates a processor and the other debugging device uses a port. As various kinds of processors are made, the former is complicate and difficult to support the processors. Therefore, the latter is widely used. Most of the devices have an additional connection unit so as to use the debugging port and various functions are provided through the connection unit. However, due to the additional unit, the price of the debugging device rises. Also, the flexibility that can interface with other devices is degraded.

### SUMMARY OF THE INVENTION

Accordingly, the present invention is directed to an embedded system debugging device and method thereof which substantially obviate one or more problems due to limitations and disadvantages of the related art.

It is an object of the present invention to provide a device and method, for debugging an embedded system, in which the device is capable of providing a flexible debugging at a low cost when software for the embedded system is developed.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a device for debugging an embedded system, which includes a host system, a JTAG signal generator, and a target system. The host system includes: a user interface for managing an interface with a user; a debugging engine for outputting information necessary for debugging when the user selects a target system to be debugged through the user interface, and for outputting a debugging process result through the user interface to the user; and a JTAG command generator for receiving an information necessary for debugging from the debugging engine and generating a corresponding debugging command, and for receiving a debugging result to the debugging engine. The JTAG signal generator receives the debugging command from the JTAG command generator of the host system and generates a corresponding JTAG signal, and transmits the debugging process result to the JTAG command generator of the host system. The target system includes: a TAP for decoding the JTAG signal inputted from the JTAG signal generator and outputting a decoded debugging command, and for outputting the debugging process result to the JTAG signal generator; and a microprocessor for receiving the decoded debugging command through the TAP controller and applying the decoded debugging command to the microprocessor and a memory to thereby execute a necessary information and a debugging command, and outputting a result to the TAP controller.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram of an embedded system debugging device according to an embodiment of the present invention;

FIG. 2 is a block diagram of a debugging engine in the embedded system debugging device shown in FIG. 1; and

FIG. 3 is a circuit diagram of a JTAG signal generator according to an embodiment of the present invention.

### DETAILED DESCRIPTION OF THE INVENTION

Reference will now be made in detail to the preferred embodiments of the present invention, examples of which are illustrated in the accompanying drawings.

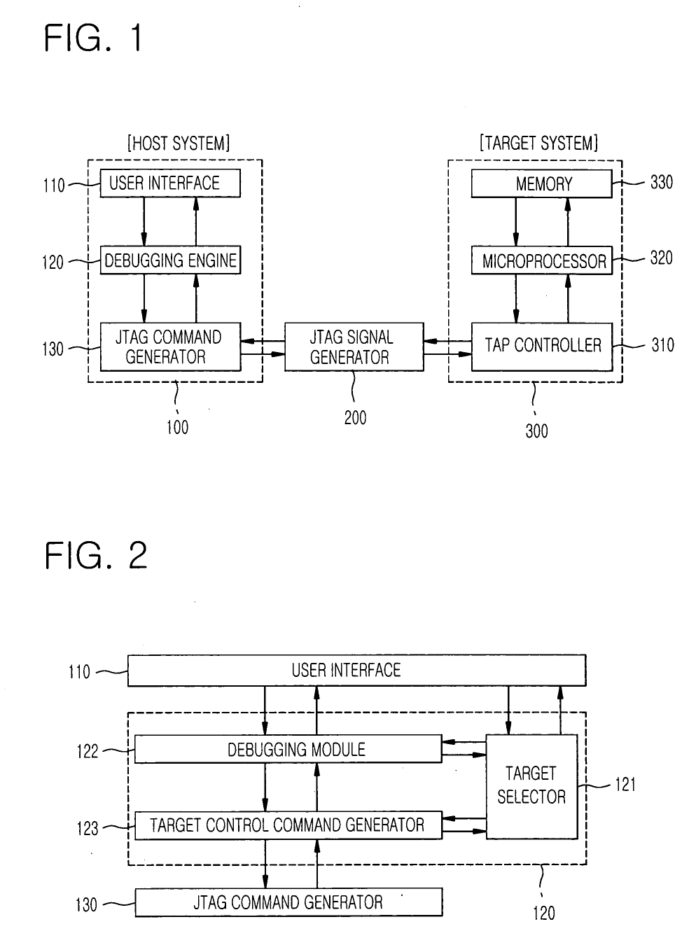

FIG. 1 is a block diagram of a device for debugging an embedded system according to an embodiment of the present invention.

Referring to FIG. 1, a debugging environment where the present invention is applied includes a host system 100, a JTAG signal generator 200, and a target system 300.

The host system 100 includes a user interface 110, a debugging engine 120 and a JTAG command generator 130. The user interface 110 manages an interface with a user. When the user selects a target system 300 to be debugged through the user interface 110, the debugging engine 120 outputs information necessary for the debugging to the JTAG command generator. Also, when the debugging engine 120 receives a debugging process result from the JTAG command generator 130, it outputs the debugging process result through the user interface 110 to the user. When the JTAG command generator 130 receives the information necessary for the debugging from the debugging engine 120, it generates a corresponding debugging command to the JTAG signal generator 200. Also, when the JTAG command generator 130 receives a debugging result from the JTAG signal generator 200, it outputs the debugging result to the debugging engine 120.

FIG. 2 is a block diagram of the debugging engine in the embedded system debugging device shown in FIG. 1.

Referring to FIG. 2, the debugging engine 120 includes a target selector 121, a debugging module 122, and a target control command generator 123. When the user selects a target through the user interface 110, the target selector 121 provides a target related information to the debugging module 122 and the target control command generator 123. The debugging module 122 receives a user command through the user interface 110 and a target information from the target selector 121, and performs the debugging operation. Meanwhile, the debugging module 122 receives the debugging result from the target control command generator 123 and outputs it to the user interface 110. The target control command generator 123 receives the information necessary for the debugging from the debugging module 122 and the target information from the target selector 121. Then, the target control command generator 123 converts the information into corresponding commands and outputs it to the JTAG command generator 130. Also, the target control command generator 123 receives the debugging result from the JTAG command generator 130 and outputs it to the debugging module 122.

Meanwhile, the JTAG signal generator 200 receives the debugging command from the JTAG command generator 130 of the host system 100 and generates the corresponding JTAG signal to the target system 300. Also, the JTAG signal generator 200 receives the debugging process result from the target system 300 and transmits it to the JTAG command generator 130 of the host system 100.

At this point, the JTAG signal generator 200 converts the command generated from the JTAG command generator 130 into the actual JTAG signal. That is, the JTAG signal generator 200 generates a clock suitable for the target system 300 and an output signal for controlling the target 300. The output signal is transmitted to a TAP controller 310 of the target system 300 and is used to control or monitor a microprocessor 320 and a memory 330, such that an intended operation is performed. Meanwhile, the signal generated from the JTAG signal generator 200 is a signal defined in “Standard Test Access Port and Boundary-Scan Architecture” of IEEE 1149.1.

Referring again to FIG. 1, the target system 300 includes a test access port (TAP) controller 310, a memory 330, and a microprocessor 320. The TAP controller 310 decodes the JTAG signal inputted from the JTAG signal generator 200 and outputs the decoded signal to the microprocessor 320. Also, the TAP controller 310 receives the debugging process result from the microprocessor 320 and outputs it to the JTAG signal generator 200. The microprocessor 320 receives the debugging command decoded by the TAP controller 310 and outputs the necessary information and the debugging result to the TAP controller 310.

Hereinafter, an operation of the device for debugging the embedded system according to an embodiment of the present invention will be described with reference to FIGS. 1 and 2.

First, in order to set the debugging environment, the user selects the target system 300 to be debugged through the target selector 121 of the debugging engine 120. At this point, information necessary for the debugging engine 120 and the microprocessor 320 of the target system 300 is transmitted. In this manner, a debugging standby state is set.

In order to debug the embedded system, the debugging engine 120 transmits the necessary information to the JTAG command generator 130, and then the JTAG command generator 130 receives the information and transmits the command to the JTAG signal generator 200. The JTAG signal generator 200 generates the JTAG signal for driving the target system 300 to the target system 300.

At this point, the signal transmitted to the target system 300 is decoded by the TAP controller 310 and is applied to the microprocessor 320 and the memory, and then the necessary information and the debugging command is executed. The result is applied in a reverse procedure and displayed to the user through the user interface 110 of the host system 100.

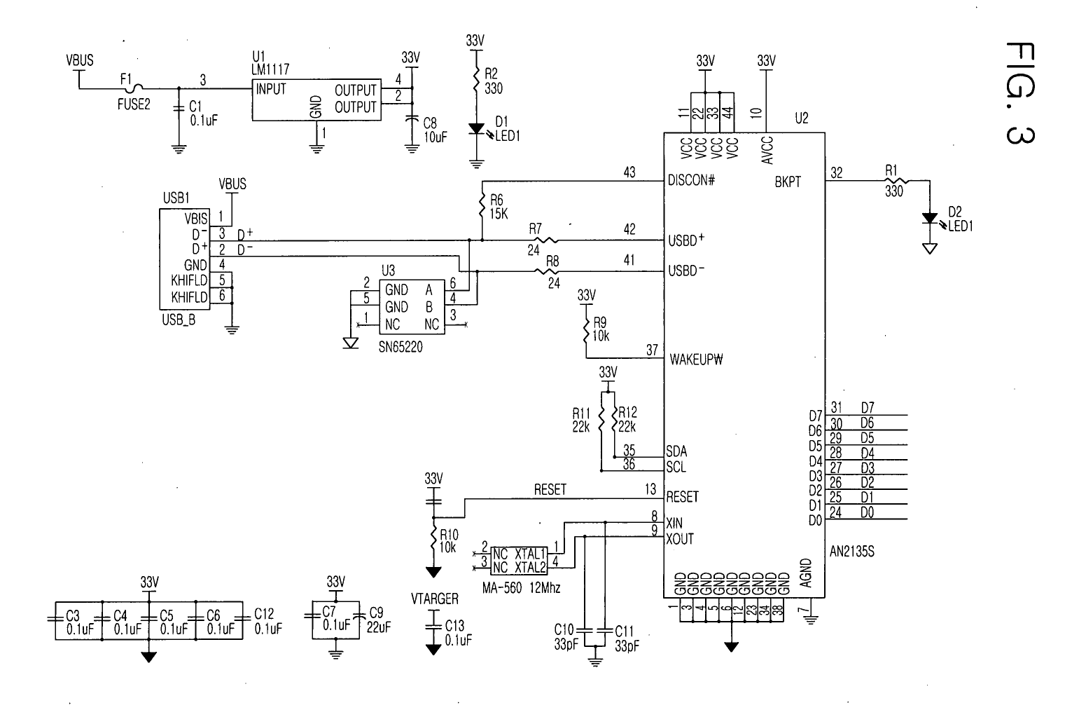

FIG. 3 is a circuit diagram of the JTAG signal generator. The JTAG signal generator 200 converts the command generated from the JTAG command generator 130 into the actual JTAG signal. The JTAG signal is transmitted to the TAP controller 310 and is used to control or monitor the microprocessor 320 and the memory 330, such that an intended operation is performed. Meanwhile, the signal generated from the JTAG signal generator 200 is a signal defined in “Standard Test Access Port and Boundary-Scan Architecture” of IEEE 1149.1.

As described above, when software for the embedded system is developed, the present invention provides a cheap and flexible embedded software debugging method. Therefore, the software of the embedded system can be debugged at a low cost by using a PC only, without any special hardware.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A device for debugging an embedded system, comprising:
a host system including:
a user interface for managing an interface with a user;
a debugging engine for outputting information necessary for debugging when the user selects a target system to be debugged through the user interface, and for outputting a debugging process result through the user interface to the user; and
a JTAG (joint test action group) command generator for receiving an information necessary for debugging from the debugging engine and generating a corresponding debugging command, and for receiving a debugging result to the debugging engine;
a JTAG signal generator for receiving the debugging command from the JTAG command generator of the host system and generating a corresponding JTAG signal, and for transmitting the debugging process result to the JTAG command generator of the host system; and
a target system including:
a TAP (test access port) for decoding the JTAG signal inputted from the JTAG signal generator and outputting a decoded debugging command, and for outputting the debugging process result to the JTAG signal generator; and
a microprocessor for receiving the decoded debugging command through the TAP controller and applying the decoded debugging command to the microprocessor and a memory to thereby execute a necessary information and a debugging command, and outputting a result to the TAP controller.

2. The device of claim 1, wherein the debugging engine includes:
a target selector for provides a target related information when the user selects the target through the user interface;
a debugging module for receiving a user command and source codes through the user interface and a target information from the target selector and performing a debugging operation, and outputting a debugging result to the user interface; and
a target control command generator for receiving the information necessary for the debugging from the debugging module and the target information from the target selector, converting the information into corresponding commands and outputting the commands to the JTAG command generator, and receiving the debugging result from the JTAG command generator and outputting the debugging result to the debugging module.

3. The device of claim 1, wherein the JTAG signal generated from the JTAG signal generator is a signal defined in Standard Test Access Port and Boundary-Scan Architecture of IEEE 1149.1.

4. A method for debugging an embedded system, comprising the steps of:
transmitting an information necessary for debugging to a JTAG command generator;
transmitting a command to a JTAG signal generator;
generating a JTAG signal necessary for driving a target by using the command and transmitting the JTAG signal to a target system; and
decoding the JTAG signal and executing a debugging command.
